(19) United States
(12) Patent Application Publication
(10) Pub. No.: US 2023/0419419 A1
(43) Pub. Date: Dec. 28, 2023

(54) SYSTEM AND METHOD FOR FACILITATING TEAM EXPERIENCES

(71) Applicant: Teamraderie, Inc., Los Altos, CA (US)

(72) Inventors: Michael P. McCarroll, Los Altos, CA (US); Irina M. Egorova, Los Altos, CA (US)

(73) Assignee: Teamraderie, Inc., Los Altos, CA (US)

(21) Appl. No.: 18/209,797

(22) Filed: Jun. 14, 2023

Related U.S. Application Data
(60) Provisional application No. 63/355,934, filed on Jun. 27, 2022.

(51) Int. Cl. G06Q 50/00

(52) U.S. Cl. CPC G06Q 50/01

(57) ABSTRACT

One embodiment can provide a system and method for facilitating team experiences. During operation, the system can receive, from a team manager, input information associated with a team; determine one or more team experiences based on the input information; receive, from the team manager, at least a selection of a team experience; and provide, to a kit provider, delivery information for a number of participants of the team experience, thereby allowing the kit provider to send an experience kit to each participant. The system can further coordinate with an experience facilitator to facilitate the team experience, monitor sentiment of the participants during the team experience, and provide real-time feedback to the experience facilitator based on the monitored sentiment of the participants.

### RELATED APPLICATIONS

This claims the benefit of U.S. Provisional Patent Application No. 63/355,934, Attorney Docket No. TMDR22-1001PSP, entitled “SYSTEM AND 15 METHOD FOR FACILITATING VIRTUAL TEAM EVENTS,” by inventors Michael P. McCarroll and Irina M. Egorova, filed 27 Jun. 2022, the disclosure of which is incorporated herein by reference in its entirety for all purposes.

### BACKGROUND

### Field

This disclosure is generally related to team experiences. Particularly, this disclosure is related to a web-based platform for facilitating in-person or virtual team experiences.

### Related Art

Since the beginning of the global COVID-19 pandemic in 2020, the way people work has undergone a significant transformation. The rapid adoption of remote work during lockdowns led to a reevaluation of traditional office-based work models, giving rise to the concept of hybrid work. Hybrid work combines elements of both remote work and in-person collaboration, allowing employees to divide their time between working from home and the office. While this model offers numerous benefits, such as increased flexibility and improved work-life balance, it also creates new challenges to work teams and their leaders.

For example, remote or hybrid work can lead to the reduction of workplace belonging and engagement among team members. Recent research has estimated that more than 40% of workers are feeling physically and emotionally isolated in the workplace. Remote work also makes it more difficult for people to maintain their ties and networks. It has been reported that people's networks become less static, and teams become less interconnected. Remote workers may also feel disconnected from the company's vision and mission. It has also been reported that 69% of leaders consider inspiring and motivating people the biggest challenge in a hybrid/remote environment.

Multiple studies have shown that keeping teams connected can increase productivity. For example, one study reported that a deeper sense of belonging in a team may result in a 56% increase in performance, a 50% decline in employee turnover, and a 75% decline in sick days. Another study demonstrated that organizations with the biggest productivity increases during the COVID-19 pandemic encouraged “small moments of engagement” among team members.

Managers have been trying to address these challenges by organizing virtual team-building activities. For example, a manager can find a local barista who can ship coffee samples to team members and then run a team coffee-tasting session via video conferencing. Organizing a virtual team-building event can involve a significant amount of effort and time as the market of team-building providers is highly fragmented, the quality of services is inconsistent, and services are typically limited to specific geographic regions and cannot cover globally distributed teams.

Moreover, coordinating team members in preparation for a team-building activity can be a complex process. For example, the manager needs to select an activity that not only meets the company's goal for the team but also respects team members' interests, preferences, restrictions, schedules, etc. Failure to do this may result in damage to the employee experience and team morale. For example, if not every person on the team likes coffee, then coffee tasting will not be a good option for the team-building event.

Currently, there are no team-building services on the market that are: (1) effective in establishing connection, commitment, and trust in corporate teams of any composition (remote/hybrid/globally distributed); (2) easy for managers to understand and purchase; (3) easy for corporate teams to use.

### SUMMARY

One embodiment can provide a system and method for facilitating team experiences. During operation, the system can receive, from a team manager, input information associated with a team; determine one or more team experiences based on the input information; receive, from the team manager, at least a selection of a team experience; and provide, to a kit provider, delivery information for a number of participants of the team experience, thereby allowing the kit provider to send an experience kit to each participant. The system can further coordinate with an experience facilitator to facilitate the team experience, monitor sentiment of the participants during the team experience, and provide real-time feedback to the experience facilitator based on the monitored sentiment of the participants.

In a variation on this embodiment, the input information can include one or more of a profile of the team, an occasion for the team experience, and a team goal.

In a further variation, the profile of the team can include one or more of size, geographic distribution, industry, history of the team, and state of member of the team.

In a further variation, the team goal can include one or more of improving trust, improving collaboration, and improving communication.

In a further variation, determining the team experiences can include applying a machine-learning technique to recommend one or more experiences based at least on the profile of the team and the team goal.

In a further variation, the system can further display the recommended experiences to the team manager to allow the team manager to select at least one experience from the recommended experiences.

In a further variation, the system can further conduct post-experience surveys and use data collected from the post-experience surveys to optimize future recommendations of experiences.

In a variation on this embodiment, monitoring the sentiment of the participants can include performing voice analysis and/or facial expression analysis.

In a further variation, the system can further apply a machine-learning technique to determine one or more actions to be recommended to the experience facilitator to improve engagement of the participants based on results of the voice analysis and/or facial expression analysis.

In a variation on this embodiment, providing the delivery information for the participants can include contacting each participant to request for a delivery address and kit-configuration information and allowing the kit provider to access the deliver address and kit-configuration.

One embodiment can provide an experience-building platform for facilitating team experiences. The platform can include: a manager interface for receiving, from a team manager, input information associated with a team; an experience-recommendation engine for recommending one or more team experiences based on the input information; and a kit-provider interface for providing, to a kit provider, delivery information for a number of participants of the team experience, thereby allowing the kit provider to send an experience kit to each participant. The platform can further include an experience-monitoring engine to monitor sentiment of the participants during the team experience and a facilitator interface for allowing an experience facilitator to facilitate the team experience. The facilitator interface is to provide real-time feedback to the facilitator based on the monitored sentiment of the participants.

### BRIEF DESCRIPTION OF THE FIGURES

FIG. 1 illustrates the block diagram of an exemplary experience-building platform, according to one embodiment of the instant application.

FIG. 2 illustrates an exemplary user interface for team managers, according to one embodiment of the instant application.

FIG. 3 illustrates an exemplary user interface for team members, according to one embodiment of the instant application.

FIG. 4 presents a flowchart illustrating an exemplary operational process of the experience-building platform, according to one embodiment of the instant application.

FIG. 5 illustrates an exemplary computer system that facilitates the operation of the experience-building platform, according to one embodiment of the instant application.

In the figures, like reference numerals refer to the same FIG. elements.

### DETAILED DESCRIPTION

### Overview

Embodiments described herein solve the technical problem of improving team-building experiences in a dynamic and changing work environment. More specifically, an online platform can be provided to connect providers of the team experiences with managers looking to engage their teams. The web-based platform can be easy for managers to understand, purchase, and use, and can ensure the effectiveness of the team experiences. The online platform can provide separate portals to the different parties involved in the team experiences, including the team managers, team members, experience facilitators, and experience-kit providers. The platform can provide various, easy-to-use tools for team managers to enable an easy selection of a team experience or team-building activity. The platform can also implement various measures to improve the experience of the team members, including tracking the status of preparation of each team member, measuring the level of engagement or the sentiment of the team members, and providing live feedback to the experience facilitators based on the measurement to allow the experience facilitators to adjust their experience-delivery strategies to increase the level of engagement of the team members.

In this disclosure, the terms “team experience,” “team event,” and “team activity” can be interchangeable and can generally refer to a group activity that may happen in person or online. The activity may include a plurality of participants with a shared goal of improving the connection, commitment, and trust among participants.

### The Experience-Building Platform

The successful execution of a team experience or team-building activity requires the involvement of multiple parties, including the team manager, the kit provider, the experience facilitator, and the team members. The team manager can be responsible for selecting a team experience based on the team profile and a predetermined team goal. The kit provider can be responsible for assembling and delivering a kit that includes physical items (e.g., props or goods) to be used during the experience by each participant of the experience. The experience facilitator can be the person leading the experience. For example, the facilitator can be a domain expert in charge of providing guidance or demonstrations to participants of the experience. If the experience is in the form of an online meeting, the facilitator can be the meeting organizer. During the experience, the facilitator can be responsible for keeping the interactive team conversation flowing and for record keeping (e.g., by capturing photos or videos of the scene of the experience). The team members are participants in the experience. Before the occurrence of the experience, the team members are required to take a number of actions to get ready, including reserving the time for participating in the experience, providing delivery addresses for the kit, receiving the kit, and setting up the physical items included in the kit, etc. During the experience, the team members can engage with the facilitator and each other and provide instant feedback.

In some embodiments of the instant application, the experience-building platform can connect these different parties at a centralized online location, regardless of the type of experience (in-person or online) or the composition of the team (e.g., local, remote, or hybrid). More specifically, the experience-building platform can include separate portals for interacting with the different parties, such as a manager portal for interacting with team managers, a kit-provider portal for interacting with kit providers, a facilitator portal for interfacing with experience facilitators, and a team-member portal for interfacing with team members. Each portal can include a unique user interface to allow each party to perform actions (e.g., inputting information, making selections, etc.) required for building the experience. Moreover, the experience-building platform can include a number of internal engines or software/hardware units that can aggregate and/or analyze information collected from the different portals. The output of the internal engines can then be provided to the different parties.

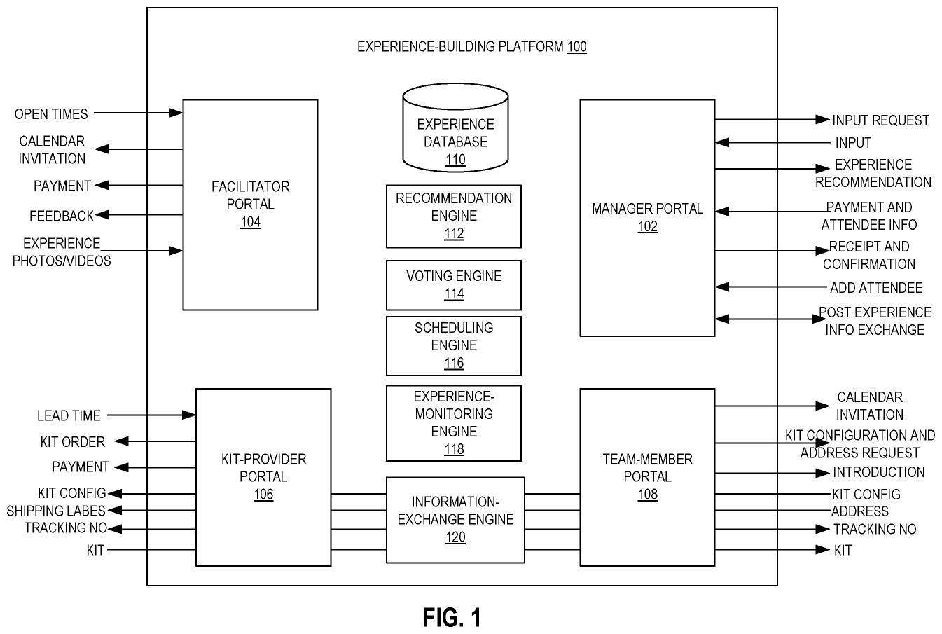

FIG. 1 illustrates the block diagram of an exemplary experience-building platform, according to one embodiment of the instant application. Experience-building platform 100 can include a number of user portals, including a manager portal 102, a facilitator portal 104, a kit-provider portal 106, and a team-member portal 108.

A team manager booking a customized experience can interact with experience-building platform 100 via manager portal 102. In addition to providing experience recommendations and allowing the team manager to select an experience for booking, manager portal 102 can also provide a way for the manager to receive input requests for customization of the experience. The manager can input the requested information via manager portal 102. Examples of the information needed for customization of the experience can include the number of team members, experience configuration information (e.g., omitted or added features), etc. The team manager can provide payment and attendee information to platform 100 via manager portal 102. For example, the manager can provide credit card information for making the payment. The manager can also provide a list of attendees and their contact information (e.g., email addresses). The manager can make modifications to the attendee information (e.g., adding or replacing attendees) after booking the experience. Platform 100 can also provide various information to the team manager via manager portal 102, including but not limited to the receipt and confirmation information, recordings (e.g., photos or videos) of the experience, the Net Promoter Score (NPS), etc. The team manager and platform 100 can also exchange post-experience information via management portal 102. Examples of the information exchanged post-experience can include follow-up discussion topics, post-experience content to be shared with team members, recommendations for future experiences, etc.

An experience facilitator can interact with experience-building platform 100 via facilitator portal 104. The proposed solution can include a methodology to source facilitators for various team experiences (e.g., experts in various domains, including small business owners), onboard them to experience-building platform 100 (e.g., by setting up facilitator accounts), and help them shape the team experiences (e.g., by providing online tools and by connecting them with kit providers). Note that a single facilitator may facilitate or provide services for different experiences. For example, a food/drink expert may facilitate different types of tasting experiences (e.g., tea, coffee, or wine tasting) as well as cooking experiences. Similarly, an artist may facilitate different types of art-related experiences (e.g., painting, sculpting, etc.). Through facilitator portal 104, a facilitator can provide calendar information (e.g., available times) to experience-building platform 100, which can in turn send out a calendar invitation as well as payment to the facilitator once an experience has been booked. To be able to receive payment, the facilitator may have previously provided information about their deposit account while setting up the facilitator account. The facilitator may also receive participant feedback via facilitator portal 104. In some embodiments, the feedback can include post-experience feedback. For example, participants of the experience may fill out a survey after the experience to provide feedback regarding the experience and the facilitator. In alternative embodiments, the feedback can include instant feedback. For example, experience-building platform 100 can include voice and/or facial expression analyzing units that can analyze the voices and facial expressions of the team members participating in the experience to determine the level of engagement between the team members and the facilitator. According to the result of the voice or facial expression analysis, experience-building platform 100 can provide real-time cues to the facilitator such that the facilitator can adjust their behaviors or perform certain actions according to how the audience is perceiving the team experience. For example, to increase audience engagement, the facilitator can perform various actions, including but not limited slowing down the presentation, pausing for questions, asking whether team members have questions, asking a question from a repository of questions, etc. After the experience, the facilitator may also provide additional material (e.g., photos or videos taken during the experience) to experience-building platform 100 via facilitator portal 104.

Kit-provider portal 106 allows a provider or supplier of the experience kits to interact with experience-building platform 100 in order to obtain information regarding the experience kit. In some embodiments of the instant application, most experiences are kit-based, meaning that they require physical kits to be delivered to team members. For example, a wine-tasting experience would require different types of wines to be delivered to the team members. Certain hands-on team collaboration experiences may also require props to be delivered to team members. For example, a simulated NASCAR pit-stop experience may require model cars and tools to be delivered to team members. The kit provider can use kit-provider portal 106 to provide lead time to the manager, receive order information, and collect payment from the manager. Moreover, kit-provider portal 106 can facilitate information exchange between the team members and the kit provider.

Experience-building platform 100 uses team-member portal 108 to interact with the team members. Once the team manager books an experience, experience-building platform 100 can use team-member portal 108 to contact each team member. For example, experience-building platform 100 can send, via team-member portal 108, a calendar invitation to each team member, notifying them of the time and location (which can be a physical location or an online meeting link) of the experience. Team-member portal 108 can also be used to collect the address information (i.e., the address for delivering the kit) from the team members. Moreover, experience-building platform 100 can send a request to each team member for kit configuration information. Note that many experiences can have user-configurable kits, meaning that the participants can configure the kit based on their personal preferences or constraints. For example, a tasting experience may use both alcoholic and non-alcoholic kits, and each team member can specify what type of kit should be shipped to them. In addition, a team member can also make a kit selection based on personal dietary restrictions (e.g., vegetarian, dairy- or gluten-free, etc.). A team member can also obtain, via team-member portal 108, introduction material (e.g., text- or video-based material) disclosing what to expect during the experience. After the kit provider ships the kit, the team member can obtain, via team-member portal 108, tracking information about the shipment.

In addition to the user portals, experience-building platform 100 can also include an experience database 110 and a number of internal engines, including a recommendation engine 112, a voting engine 114, a scheduling engine 116, an experience monitoring engine 118, and an information-exchange engine 120.

Experience database 110 can store information about a plurality of experiences. The experiences have been developed based on the principles and rules derived from academic research on what creates connection, commitment, and trust in teams. In some embodiments, the experiences stored in database 110 can be organized by team goals. For example, some experiences can be most effective in developing team trust, whereas some other experiences may be used to promote effective communication among team members. In alternative embodiments, the experiences can be organized by use cases or occasions. Examples of the use cases can include but are not limited to “team planning session,” “project launch,” “brainstorming,” “team bonding,” “crunch time,” “milestone celebration,” “workshop,” etc. An experience stored in database 110 can be tagged based on the team goal and the use case. In many cases, an experience may serve multiple purposes and can be used in different use cases, and such an experience may include multiple tags.

Recommendation engine 112 can be used to recommend an optimized solution to a team manager based on the profile of the team and the desired team goal. In some embodiments, the team manager can answer a number of questions (which can include “yes/no” or multiple-choice questions) about the profile and state of their team, for example: “industry,” “function,” “size,” “geographic distribution (e.g., whether it is distributed internationally),” “team history (e.g., length of time working together),” “state of the team members (e.g., presence of new employees, whether the team feels fatigued or energized, whether the team feels disengaged or engaged),” etc. The team manager can also specify one or more team goals, such as “improving trust,” “improving collaboration,” “improving communication,” etc. In some embodiments, recommendation engine 112 can include a machine-learning model that takes the team profile and/or the team goals as input. The output of the machine-learning model can be an optimized solution for the team. In some embodiments, the solution can include a team experience or a sequence of team experiences. The experiences can include both in-person and virtual experiences. The machine-learning model can be trained based on the post-experience feedback from team managers. For example, after going through an experience, the team manager can be presented with a number of survey questions regarding the effects of the experience on the team. Examples of the questions can include asking the manager to rate the effectiveness of the experience on a scale from 1 to 10. The accuracy of the model can be improved as the number of teams going through the team experiences increases. In some embodiments, platform 100 can include a survey engine (not shown in FIG. 1) that can be responsible for conducting the post-experience surveys to the team manager and the team members. Recommendation engine 112 can be implemented using hardware components, software components, and a combination thereof. In one embodiment, recommendation engine 112 can be implemented using specialized hardware such as application-specific integrated circuits (ASICs).

Voting engine 114 can provide an optional “team member voting” feature. Certain team managers may wish to involve their team members in the decision-making process regarding which experience to purchase. To do so, the team manager can activate the “voting” feature provided by voting engine 114. In some embodiments, voting engine 114 can cause team-member portal 108 to present a list of candidate experiences to team members to allow each team member to vote for their preferred experiences. The candidate experiences can be selected by the manager or recommended by recommendation engine 112. In one example, each team member can vote for one experience. In an alternative example, each team member can indicate their top three experiences. Other voting mechanisms can also be possible. Voting engine 114 can further count the votes from all team members and present the voting result to the team manager via manager portal 102.

Scheduling engine 116 can be responsible for handling various tasks associated with the scheduling of the experience, including generating a calendar that displays the possible times for the experience based on a number of factors, including the availability of the facilitator and the lead time for delivering the kit. Note that the lead time for delivering the kit can depend on how distributed the team is. An international team with globally distributed team members often requires longer lead times. Scheduling engine 116 can also be responsible for generating and sending calendar invitations to the manager and team members.

Experience monitoring engine 118 can be responsible for monitoring the behavior and sentiment of the team members during the experience. For online experiences, experience monitoring engine 118 can interface with the video conference application to obtain audio or video information about the scene. Experience monitoring engine 118 can further perform voice or facial expression analysis based on the audio or video information in order to determine the level of engagement of the team members. Such information can be provided to the facilitator to allow the facilitator to adjust their behavior or take certain actions based on the level of engagement of the audient. For example, a facilitator may pause to allow the audience to ask questions or ask the audience a question in order to engage the audience. Experience monitoring engine 118 can also record the types of stimuli applied by the facilitator and their impact on the audience. In one embodiment, a machine-learning model can be trained to learn what type of stimuli can effectively increase engagement in what situation. The trained model can then be applied during the experience to continuously optimize the engagement of the team members. For in-person experience, experience monitoring engine 118 can interface with one or more voice and/or image sensors arranged at the meeting location and configured to record voices and/or images of participants of the experience. For online or virtual experience, experience monitoring engine 118 can interface with the voice and image sensors embedded in the online-meeting platform to obtain voices and/or images of the participants.

Information-exchange engine 120 can facilitate various types of information exchange among the parties involved in the experience. More specifically, it can enable information exchange with the facilitators and the kit providers. In some embodiments, information-exchange engine 120 can include components such as a catalog of experience facilitators and kit suppliers, their mapping to team experiences, workflows for experience kits inventory forecasting, workflows for experience kits delivery to team members in time for their experiences, workflows enabling payments and rewards to facilitators and kit providers based on multiple parameters (e.g., orders fulfilled, experience facilitated, performance on experiences, etc.). Information-exchange engine 120 can receive data about experience orders from team managers as a key input and enable timely and seamless execution of all aspects of the team experiences. In one example, information-exchange engine 120 can facilitate the team members in providing their delivery addresses to the kit provider. Information-exchange engine 120 can also interface with external platforms to allow certain information to be exchanged between platform 100 and the external platforms. For example, information-exchange engine 120 can interface with a delivery company's customer-service platform to obtain delivery information. For example, a team member's delivery address can be provided to the custom-service platform such that a shipping label can be generated and sent to the kit provider. Moreover, after the kit provider ships the kit, the custom-service platform of the delivery company can send the tracking information to the team member.

Compared with traditional approaches to providing team experiences, the experience-building platform can provide a number of advantages. One advantage is that the platform can be effective in establishing connection, commitment, and trust in a corporate team regardless of the size and geographical distribution of the team. As discussed previously, the team experiences provided through the platform have been developed based on principles and rules derived from academic research on what creates connection, commitment, and trust in teams.

By organizing the experiences based on desired team goals, the platform can provide experiences that are purposeful. Most experiences can be kit-based to enhance the engagement of team members. The experiences can be expertise-centric because the platform provides an easy-to-use facilitator portal to allow experts in various domains to facilitate the experiences. The team experiences can be interactive by including an orchestrated sequence of team learning, team discussion, and hands-on exercises. The effect of the team experience can be long-lasting, as the team managers can be provided with follow-up discussion topics and content to share with the team after the team experience.

The effectiveness of the experiences can be enhanced further using machine-learning techniques to provide experience recommendations based on the team profile and team goals. For example, a machine-learning-based experience-recommendation engine can recommend an experience or a sequence of experiences that are suitable for the team based on the team profile and can optimize the team goals. Moreover, during the experience, a machine-learning-based action-recommendation engine can recommend one or more actions to be taken by the facilitator to improve the engagement of the participants of the experience.

Another benefit provided by the platform is that it makes it easier for team managers to understand and purchase team experiences. The platform can provide an online marketplace where team managers can access, explore, and purchase a team experience. The marketplace can be presented to the team manager in a graphic user interface (GUI). In some embodiments, the platform can be implemented as a web-based application, where the online marketplace can be accessed via a webpage. In some embodiments, the platform can be implemented as a mobile application, where the online marketplace can be accessed by launching the application.

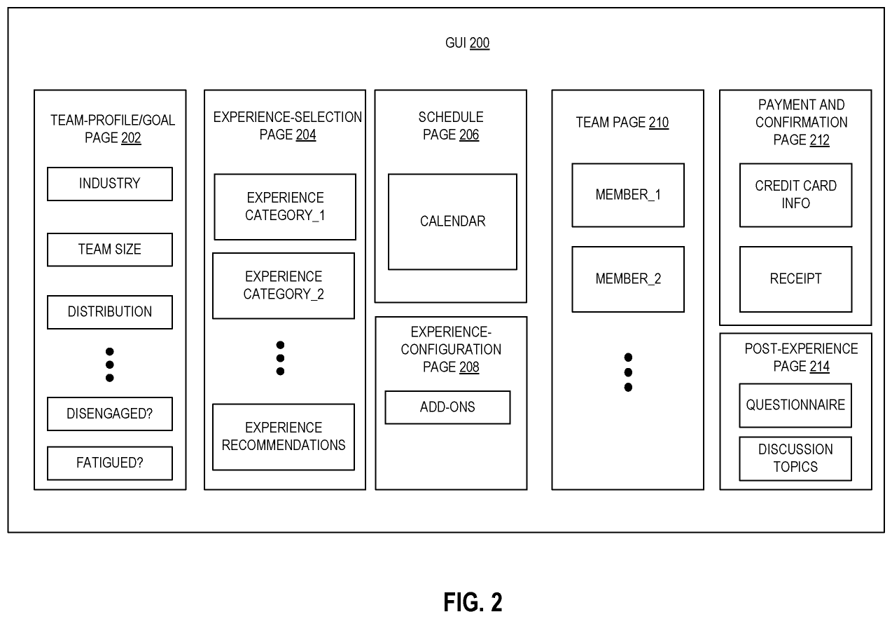

FIG. 2 illustrates an exemplary user interface for team managers, according to one embodiment of the instant application. GUI 200 can include a number of pages, including a team-profile/goal page 202, an experience-selection page 204, a schedule page 206, an experience-configuration page 208, a team page 210, a payment and confirmation page 212, and a post-experience page 214. For simplicity of illustration, the multiple pages are shown as co-existing in GUI 200. In practice, the pages may be presented in GUI 200 one by one according to a predetermined order. For example, schedule page 208 may be presented after the manager selects an experience in experience-selection page 206. In alternative embodiments, these different pages can be shown as different tabs in the same window.

Team-profile/goal page 202 can include a number of dropdown menus for the team manager to input information about the team and to specify the desired team goal to be achieved via the experience. The dropdown menus for the team profile can include a number of yes/no menus and a number of multiple-choice menus. These menus allow the manager to answer questions about the profile and the current state of the team (e.g., mental or emotional state of the team members). For example, the manager can answer questions about the industry, size, and geographical distribution of the team. In addition, the manager can also specify whether the team feels disengaged or fatigued. The dropdown menu for the team goal can include a number of goal selections, including “improving trust,” “improving collaboration,” “improving communication,” etc. The manager can select one team goal or a combination of team goals.

Experience-selection page 206 can display the experience options. In some embodiments, the experiences can be organized and displayed in different categories. For example, the experiences can be classified by use cases, such as “team-planning session,” “project launch,” “brainstorming,” “team bonding,” “crunch time,” “milestone celebration,” “workshop,” etc. Experiences in the same category can be grouped for display.

To assist the team manager in selecting one or more experiences, experience-selection page 206 can also display a number of filter tools to allow the manager to input multiple parameters to filter the available team experiences. The parameters can include but are not limited to price, use case, team goal, relevance to various team profiles, etc.

Experience-selection page 206 can further display a number of recommended experiences. As discussed previously, the platform can include a machine-learning-based experience-recommendation engine capable of recommending one or more experiences based on the team profile and team goals provided by the manager. More specifically, the machine-learning model can take as input the team profile and team goals and output an optimized solution comprising one or more experiences. The solution can optimally match the team profile and effectively achieve the team goals. The machine-learning model can be continuously trained and improved as more teams are going through the experiences and the number of data points about these teams grows.

Schedule page 208 can display a calendar, indicating to the team manager the available time slots for a selected experience. When displaying the available time slots, the system can automatically consider the real-time availability of the experience facilitator and the logistic constraints for the kit delivery. For example, if the team is a global team that requires some kits to be shipped overseas, the system will consider the extra shipping time when determining the available time slots. The team manager can select an available time slot using the calendar. Experience-configuration page 210 can allow the team manager to customize the experience by enabling or disabling certain experience features or add-ons.

Team page 212 allows the team manager to input a list of team members. In some embodiments, the team manager can create an entry for each team member. The entry can include the team member's name and contact information (e.g., an email address). The entry can further include information about the team member's progress in preparation for the experience (e.g., whether the kit has been received). Team page 212 can also provide a summary of the progress of the team as a whole (e.g., the percentage of members ready for the experience). The team manager can access team page 212 anytime during the preparation stage of the team experience. The team manager can also add or remove team members through team page 212.

Payment and confirmation page 214 can allow the team manager to enter payment information to purchase the selected experience(s). For example, the team manager can provide credit card information or fill out a purchase order. An order confirmation would appear on payment and confirmation page 214 once the order is completed.

Post-experience page 214 can display post-experience content to the team manager. For example, the post-experience content can include a questionnaire or survey to allow the team manager to provide feedback regarding the effectiveness of the experience. The post-experience content can also include follow-up discussion topics to be shared with the team. These follow-up discussion topics can further enhance the effectiveness of the experience in achieving the team goal. The post-experience content can also include recordings (e.g., videos or photos) of the experience.

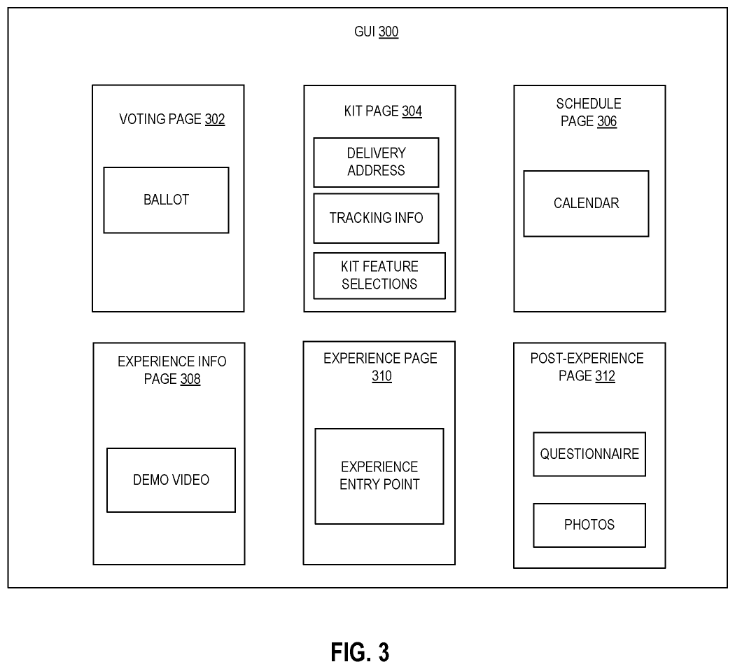

FIG. 3 illustrates an exemplary user interface for team members, according to one embodiment of the instant application. GUI 300 can include a number of pages, including a voting page 302, a kit page 304, a schedule page 306, an experience-introduction page 308, an experience page 310, and a post-experience page 312. Although FIG. 3 shows multiple pages appear together in GUI 300, in practice, these pages may appear in GUI 300 one by one according to a predetermined order. For example, voting page 302 may appear first, followed by kit page 304.

Voting page 302 can be optional and can appear in GUI 300 when the team manager activates a voting feature to include the team members in the experience selection process. Voting page 302 can include a ballot showing a pre-selected list of experiences. Each team member can indicate one or more desired experiences. The anonymous voting result can be presented to the team manager. Voting can allow the team manager to select an experience that not only can address the team's goal and match the team's profile and occasion, but also be liked by the team members.

Kit page 304 can facilitate secure communications between the team member and the kit provider. A team member can enter a delivery address or change a previously entered address in an address field on kit page 304. Kit page 304 can display a link to the delivery company's website to allow the team member to track the delivery status of the kit. Kit page 304 can further include a tool to allow the team member to configure the kit (e.g., selecting kit features) according to personal preference. Note that information displayed on kit page 304 can be accessed by the kit provider such that the kit provider can configure the kit and send the kit to the team member accordingly.

Schedule page 306 can display a calendar that indicates the time of the experience. Experience-introduction page 308 can display materials (e.g., textual descriptions or demo videos) that introduce the experience such that the team member can know what to expect before the experience. For a virtual experience, experience page 310 can provide the entry point (e.g., a link to the online meeting room). The online-meeting application can be part of the experience-building platform or be provided by an external service.

Post-experience page 312 can display post-experience content to the team member, such as a structured questionnaire or survey and experience photos. The structured questionnaire can be carefully designed to collect feedback and capture the sentiment of the team member regarding the experience. In some embodiments, the feedback can include the NPS score. Team members' responses to the structured questionnaire can be subsequently used by the platform to recommend optimal team experiences to managers based on their team profile and goals.

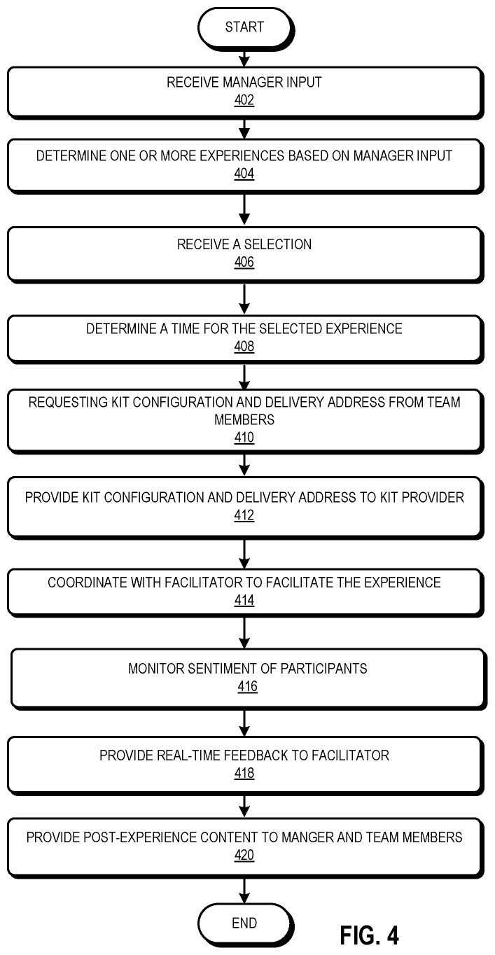

FIG. 4 presents a flowchart illustrating an exemplary operational process of the experience-building platform, according to one embodiment of the instant application. During operation, the platform can receive input information from a team manager (operation 402). The input information can include the team-profile information and the team-goal information. In one embodiment, the input information can also specify a use case or an occasion for a desired experience.

The platform can determine one or more experiences based on the manager's input (operation 404). In some embodiments, a machine-learning technique (e.g., a deep-learning neural network) can be used to recommend one or more experiences that can match the team's profile/occasion and optimize the team goal. The platform can display the recommended experiences to the team manager and receive a selection from the team manager (operation 406). The platform can subsequently determine a time slot for the selected experience to occur (operation 408). More specifically, the time can be determined based on a number of factors, including the preference of the team manager, the availability of the facilitator, and the time needed for delivering the kits to all team members.

The platform can request the individual kit configuration information and the delivery address from each team member (operation 410) and provide such information to the kit provider (operation 412). At the scheduled time slot, the platform can coordinate with the experience facilitator to facilitate the team experience (operation 414). For a virtual team experience, the platform can provide an online meeting place for the facilitator and the team members.

During the meeting, the platform can monitor the sentiment of the participants (operation 416). Monitoring the sentiment of the participants can involve configuring one or more voice and/or image sensors to record voices and/or images of participants. For in-person experience, a number of voice and/or image sensors can be arranged at the meeting location and configured to record the experience scene. For online or virtual experience, voice and image sensors embedded in the online-meeting platform can be activated to obtain voices and/or images of the participants. In some embodiments, the platform can perform voice and facial expression analysis to determine the level of engagement of the team members. Based on the monitored sentiment, the platform can provide real-time feedback to the facilitator (operation 418) to allow the facilitator to adjust their behavior to improve the engagement of the participants. After the experience, the platform can provide post-experience content to the team manager and team members (operation 420). The post-experience content can include but is not limited to a structured questionnaire for collecting feedback from the manager and team members, follow-up discussion topics, and experience photos.

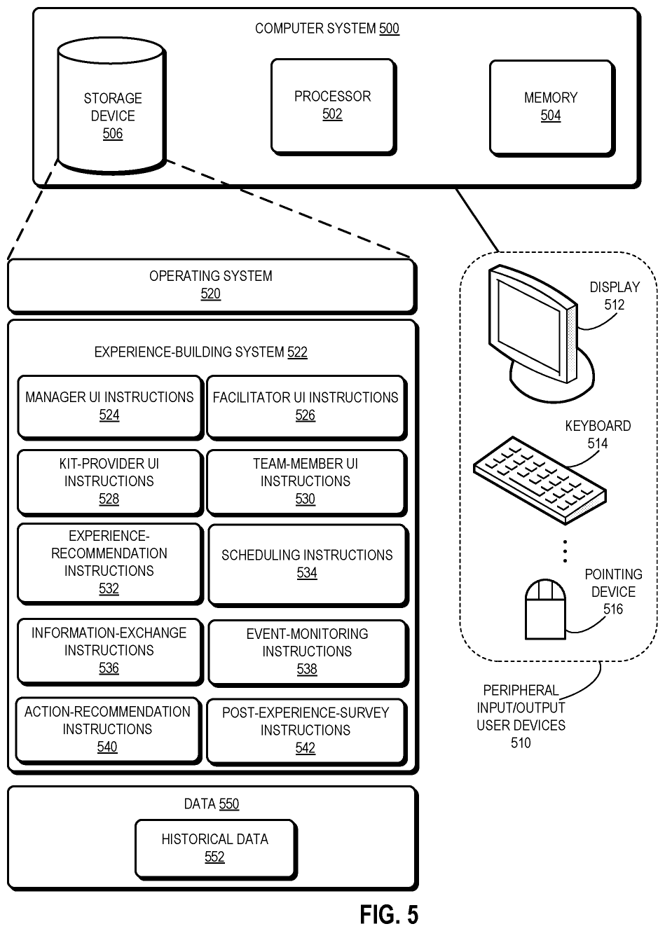

FIG. 5 illustrates an exemplary computer system that facilitates the operation of the experience-building platform, according to one embodiment of the instant application. Computer system 500 includes a processor 502, a memory 504, and a storage device 506. Furthermore, computer system 500 can be coupled to peripheral input/output (I/O) user devices 510, e.g., a display device 512, a keyboard 514, and a pointing device 516. Storage device 506 can store an operating system 520, an experience-building system 522, and data 540.

Experience-building system 522 can include instructions, which when executed by computer system 500, can cause computer system 500 or processor 502 to perform methods and/or processes described in this disclosure. Specifically, experience-building system 522 can include instructions for implementing a manager UI (manager UI instructions 524), instructions for implementing a facilitator UI (facilitator UI instructions 526), instructions for implementing a kit-provider UI (kit-provider UI instructions 528), instructions for implementing a team member UI (team-member UI instructions 530), instructions for recommending experiences based on team profile/occasion and team goals (experience-recommendation instructions 532), instructions for scheduling the experience (scheduling instructions 534), instructions for facilitating the information exchange between the team members and the kit-provider (information-exchange instructions 536), instructions for monitoring the experience (experience-monitoring instructions 538), instructions for recommending actions to the facilitator in real-time (action-recommendation instructions 540), and instructions for conducting post-experience survey (post-experience-survey instructions 542). Data 550 can include historical data 552 collected from a plurality of teams going through various experiences, which can be used to improve the accuracy of the machine-learning-based recommendation engines.

In general, embodiments of the present invention can provide a system and method for improving team-building experiences in a dynamic and changing work environment. Compared with conventional approaches, the provided experience-building platform can be effective in establishing connection, commitment, and trust in corporate teams of any composition. The platform can provide an online marketplace that is easy for team managers to access, explore, and purchase experiences for their team. The platform can use machine-learning technologies to recommend experiences that match the team profile/occasion and optimize the team goal. The platform can automate the complex process of coordinating team members in preparation for the team-building experience by automatically fulfilling a series of touch points following the team experience order by a team manager and before the occurrence of the team experience. These touch points can include sending calendar invitations to team members, collecting address information from team members, sending tracking information for delivery of experience kits, and sending guidelines on how to prepare for the virtual team experience. The platform can also include a feedback-collection mechanism that can collect feedback regarding the experience from the team manager and members. Such information can be used to improve the accuracy of the experience recommendation.

The foregoing description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware devices or apparatus. The hardware modules or apparatus can include, but are not limited to, application-specific integrated circuit (ASIC) chips, field-programmable gate arrays (FPGAs), dedicated or shared processors that execute a particular software unit or a piece of code at a particular time, and other programmable-logic devices now known or later developed. When the hardware devices or apparatus are activated, they perform the methods and processes included within them.

What is claimed is:

1. A method for facilitating team experiences, the method comprising:
receiving, from a team manager at an experience-building platform, input information associated with a team;
determining one or more team experiences based on the input information;
receiving, from the team manager, at least a selection of a team experience;
providing, to a kit provider, delivery information for a number of participants of the team experience, thereby allowing the kit provider to send an experience kit to each participant;
coordinating with an experience facilitator to facilitate the team experience;
monitoring, by at least a voice sensor and/or an image sensor, sentiment of the participants during the team experience; and providing real-time feedback to the experience facilitator based on the monitored sentiment of the participants.

2. The method of claim 1, wherein the input information comprises one or more of:
a profile of the team;
an occasion for the team experience; and
a team goal.

3. The method of claim 2, wherein the profile of the team comprises one or more of:
size;
geographic distribution;
industry;
history of the team; and
state of members of the team.

4. The method of claim 2, wherein the team goal comprises one or more of:
improving trust;
improving collaboration; and
improving communication.

5. The method of claim 2, wherein determining the team experiences comprises applying a machine-learning technique to recommend one or more experiences based at least on the profile of the team and the team goal.

6. The method of claim 5, further comprising displaying the recommended experiences to the team manager to allow the team manager to select at least one experience from the recommended experiences.

7. The method of claim 5, further comprising:
conducting post-experience surveys; and
using data collected from the post-experience surveys to optimize future recommendations of experiences.

8. The method of claim 1, wherein monitoring the sentiment of the participants comprises performing voice analysis and/or facial expression analysis.

9. The method of claim 7, further comprising applying a machine-learning technique to determine one or more actions to be recommended to the experience facilitator to improve engagement of the participants based on results of the voice analysis and/or facial expression analysis.

10. The method of claim 1, wherein providing the delivery information for the participants comprises:
contacting each participant to request a delivery address and kit-configuration information; and
allowing the kit provider to access the delivery address and kit-configuration.

11. An experience-building platform for facilitating team experiences, the platform comprising:
a manager interface for receiving, from a team manager, input information associated with a team;
an experience-recommendation engine for recommending one or more team experiences based on the input information;
a kit-provider interface for providing, to a kit provider, delivery information for a number of participants of the team experience, thereby allowing the kit provider to send an experience kit to each participant;
an experience-monitoring engine to monitor, using at least a voice sensor and/or an image sensor, sentiment of the participants during the team experience; and
a facilitator interface for allowing an experience facilitator to facilitate the team experience, wherein the facilitator interface is to provide real-time feedback to the facilitator based on the monitored sentiment of the participants.

12. The experience-building platform of claim 11, wherein the input information comprises one or more of:
a profile of the team;
an occasion for the team experience; and
a team goal.

13. The experience-building platform of claim 12, wherein the profile of the team comprises one or more of:
size;
geographic distribution;
industry;
history of the team; and
state of members of the team.

14. The experience-building platform of claim 12, wherein the team goal comprises one or more of:
improving trust;
improving collaboration; and
improving communication.

15. The experience-building platform of claim 12, wherein the experience-recommendation engine is to apply a machine-learning technique to recommend one or more experiences based at least on the profile of the team and the team goal.

16. The experience-building platform of claim 15, wherein the manager interface is to display the recommended experiences to the team manager to allow the team manager to select at least one experience from the recommended experiences.

17. The experience-building platform of claim 15, further comprising a survey unit to conduct post-experience surveys, wherein the experience-recommendation engine is to use data collected from the post-experience surveys to optimize future recommendations of experiences.

18. The experience-building platform of claim 11, wherein the experience-monitoring is to perform voice analysis and/or facial expression analysis.

19. The experience-building platform of claim 18, further comprising an action-recommendation engine to apply a machine-learning technique to determine one or more actions to be recommended to the experience facilitator to improve engagement of the participants based on results of the voice analysis and/or facial expression analysis.

20. The experience-building platform of claim 11, wherein the kit-provider interface is to:
contact each participant to request a delivery address and kit-configuration information; and
allow the kit provider to access the delivery address and kit-configuration.
